(19) United States
(12) Patent Application Publication
(10) Pub. No.: US 2026/0116120 A1
(43) Pub. Date: Apr. 30, 2026

(54) CARRIER FOIL, TRANSFER FOIL, LAMINATE AND METHODS OF PRODUCING THEM

(71) Applicant: UPCO S.R.L., GORIZIA (IT)

(72) Inventors: Jochen PISCH, Weilheim (DE); Heinz HALLER, Plochingen (DE); Ingeborg HALLER, Plochingen (DE)

(21) Appl. No.: 19/433,562

(22) Filed: Dec. 26, 2025

Related U.S. Application Data
(62) Division of application No. 18/026,915.

(51) Int. Cl. B44C 1/17

(52) U.S. Cl. CPC B44C 1/1729

(57) ABSTRACT

A carrier foil for transferring a coating onto a substrate covered with a melamine resin film, wherein the carrier foil comprises a foil with an upper foil surface and a lower foil surface, wherein the lower foil surface facing the substrate has a roughness Rz of 0.1 μm up to 100 μm and the upper foil surface has a roughness Rz of 0.1 μm up to 100 μm. A transfer foil and corresponding methods and laminates are also described.

### RELATED APPLICATIONS

This application is a divisional of U.S. application Ser. No. 18/026,915 filed Mar. 17, 2023, which is the National Stage of International Application No. PCT/EP2020/076317 filed Sep. 21, 2020, all of which are herein incorporated by reference.

### FIELD OF THE INVENTION

The invention relates to a carrier foil for wood substrate based laminate production, methods for the production and use of such a foil and the laminate product derived from its use.

### BACKGROUND OF THE INVENTION

Prior art variously describes treated PET (polyethylene terephthalate) foils, e. g. with regard to adhesive tapes as taught in DE 10 2004 058281 A1. Further, treated PET foils that are used to attach a multi-layer coating to wood substrates in order to form, for example, laminate floor panels are known from EP 2 920 232 B1. While the PET foil forms part of the multilayer structure of the laminate in these situations, the PET foil can also be used to transfer a coating to the substrate by means of a press, wherein the carrier foil is subsequently removed. In order to achieve an anti-finger print effect, the PET foil is designed with a rough surface oriented toward the substrate, so that the produced laminate exhibits a rough, matt, non-reflective surface. The surface of a PET carrier foil facing the press is left untreated, i. e. smooth and even.

However, as PET and, in general, plastic foils are air-tight, their application in a press is a delicate process that requires a protocol carried out with well-adjusted parameters and tools. Specifically, it turns out that wood substrates, especially particle boards but also MDF- (medium density fiberboard), HDF- (high density fiberboard) and OSB-boards (oriented strand board) generally have an inhomogeneous density distribution. When forming a laminate structure, the wooden substrate is covered with a melamine resin treated decorative paper, which will later determine the optical features of the laminate. In order to achieve special surface properties like antifingerprint, soft touch or high chemical and mechanical resistance, further layers, such as varnish, are deposited on top of the resin layer. To form a laminate, all these layers need to be joined in a press process, for example in a short cycle press or under continuous pressure. When a foil is used to deposit the varnish or further layers of resin, in short any kind of coating above the decorative paper layer, the foil is in the press when the laminate is formed, i. e. when pressure is applied. In order to form a laminate, pressure and heat will have to reach a point at which the resin becomes at least partially fluid again for some time. In combination with a carrier foil and a wooden, inhomogeneous substrate, this can cause problems, as air is usually trapped in between the carrier foil and the press. As the laminate below the carrier foil is not yet rigid, the resin and other components can still migrate. Thus, if an air bubble is trapped between the press and the air-tight carrier foil, the air bubble will preferentially laterally migrate to a point of low substrate (wood board) density, which is typically present in the above described wood substrates.

Therefore, when the laminate is formed and becomes rigid, dents appear in the final product after the carrier foil is removed.

A strategy for a solution for this problem would be to create a rough press surface in order to let air escape. However, in order to effectively let air escape, the surface of the press should have a wrinkled surface structure with long channels. Further, the profile of the press is usually carried over to the laminate in the press process. This means that a very dominant texture of the press plate destroys the optical and haptic properties of a functional surface, such as an anti-fingerprint surface. A desirable profile is therefore about as fine or finer than the profile of the laminate in terms of surface roughness. For the laminate varnish, a roughness Rz of about 0.1-100 μm according to ISO 4287 is necessary in order to achieve a non-reflective anti-finger print surface, preferably a roughness Rz of 1-50 μm, still preferably 5-15 μm. Further, a surface roughness RSm of 0.1-1000 μm, preferably 0.5-500 μm, still preferably 5-100 μm of the foil according to ISO 4287 is preferred. To date, it has not been possible to achieve a press surface that exhibits the desired surface roughness.

The present invention faces these problems.

The solution to this problem, as presented herein, consists of a carrier foil comprising a rough surface on both sides and used in a press with a smooth or even surface. It turns out that, if only the carrier foil is treated, negative effects occurring due to the transfer of a rougher press profile can be avoided, as the carrier foil can be treated to comprise the desired fine, wrinkly profile that allows a channel-like structure so that air can escape. Treatment of the foil may follow the same protocol on both sides, i. e. deposition of a suitable acrylic varnish followed by micro folding due to short-wave monochromatic UV radiation and final curing by UV light or electron beam after micro folding.

The solution presented is advantageous, as it allows high quality products to be made from lower quality substrates with inhomogeneous spatial density distributions. It is especially advantageous for the production of laminates with gloss levels of 0.5 to 5 at 60° and gloss levels of 1 to 15 at 85° as measured according to DIN 67530 or EN ISO 2813.

### SUMMARY OF THE INVENTION

In one aspect of the invention, a carrier foil is provided for transferring a coating onto a melamine resin film on a substrate. The carrier foil comprises a foil, which may comprise any suitable plastic, e. g. PET. The foil comprises a lower foil surface with a roughness Rz of 0.1 μm up to 100 μm according to ISO 4287 and, preferably, a surface roughness RSm of 0.1-1000 μm, more preferably 0.5-500 μm, still more preferably 5-100 μm according to ISO 4287 and also an upper foil surface with a roughness Rz of 0.1 μm up to 100 μm according to ISO 4287 and, preferably a surface roughness RSm of 0.1-1000 μm, more preferably 0.5-500 μm, still more preferably 5-100 μm according to ISO 4287. The two surfaces need not have the same roughness. Upper and lower refer to the position of the surfaces when imagined in a press, wherein the lower surface faces the substrate and the upper surface faces the press. Compared to prior art, in which only one of the foil's surfaces has a roughness as described above, the upper foil surface's roughness allows air between the press and the carrier foil to be expelled from the press. Thus no bubbles that cause dents in the produced laminate can form. Further, no press profile, which would be rougher than the foil surface roughness, is necessary to achieve this result. Thus the carrier foil as described allows the production of laminates with the desired roughness, leading to an anti-fingerprint effect, regardless of a possibly inhomogeneous substrate density.

Preferably, the upper foil surface has a wrinkled structure. A wrinkled structure provides long channels for air to leave the space between the press and the carrier foil. It thus promotes the effective expulsion of air.

Preferably, the foil comprises PET, as PET is a well-studied substrate for the surface treatment methods used.

Preferably, the carrier foil's upper and lower foil surfaces comprise radiation-cured acrylic varnish, as acrylic varnish can be exposed to monochromatic, short-wave UV-light in order to form a microfolded surface structure containing wrinkles and the desired roughness and subsequently to UV-light or an electron beam to fully cure the surface.

Preferably, the carrier foil is used as part of a transfer foil, which also comprises a coating, which comprises an upper coating layer comprising acrylic varnish and a lower coating layer comprising acrylated melamine resin. The acrylic varnish provides a rigid, wear resistant outer layer, whereas the acrylated melamine resin has superior adhesion to the melamine resin film on the substrate.

In another aspect of the invention, a method for manufacturing a carrier foil is disclosed. Said method comprises providing a foil, providing a varnish as a wet layer on one surface of the foil, forming one of upper or lower foil surfaces by curing the varnish in order to obtain a microfolded wrinkled surface with a roughness Rz of 0.1 μm up to 100 μm and repeating the process for a second surface of the foil, thereby forming the other of the upper or lower foil surface with a roughness Rz of 0.1 μm up to 100 μm, wherein the roughness of the upper foil surface need not necessarily be the same as the roughness of the lower foil surface. The aforementioned method enables the manufacture of a carrier foil suitable for the dent-free transfer of a multi-layer coating to several substrates, such as particleboards, MDF, HDF and OSB. Overall however, any roughness value within the range given will yield superior results in order to achieve an anti-finger print surface on the substrate of the kind described above for the carrier foil itself.

In a further aspect of the invention, such a carrier foil is part of a transfer foil, which also comprises a coating. The method of producing said transfer foil thus comprises providing the carrier foil, providing an upper coating layer deposited on the lower foil surface comprising acrylic varnish, wherein the acrylic varnish is not fully cured at first, and providing a lower coating layer comprising acrylated melamine resin. Thereafter, both layers are fully cured. As mentioned above, these production steps enable the manufacture of a transfer foil with superior release characteristics while at the same time providing a coating with superior adhesive properties.

In still a further aspect, a carrier foil as described or produced as described previously is used to manufacture a laminate. Therein, a multilayer laminate structure is produced by applying a coating to a melamine resin covered wood substrate using said carrier foil in a press under heat and/or pressure, whereby the lower foil surface (profile) is transferred to the laminate coating and the carrier foil is removed thereafter. The transfer to the coating leads to a wear-resistant upper surface of the laminate with a certain profile that enables an anti-finger print, i. e. matt, effect. On the other hand, the carrier foil enables a simplified transfer of the coating, whereas the rough upper surface of the carrier foil lets air escape, so that no bubbles can form and cause dents in the coating. Preferably, the wood substrate is a particleboard, MDF-, HDF- or OSB-board. On those wood substrates, inhomogeneous density distributions are very common and, as mentioned above, areas of low density can cause air between press and carrier foil to accumulate and cause dents in the coating.

Still preferably, the carrier foil is used in a short-cycle press. Production in a short cycle press is especially susceptible to trapped air, thus the carrier foil as described above is especially effective in avoiding dents in a short-cycle press.

Still preferably, as described above, the coating is subdivided into two layers, an upper coating layer (which forms the laminate surface) comprising acrylic varnish and a lower coating layer comprising acrylated melamine resin or other suitable adhesion promoters, such as Isocyanate for superior adhesion.

A further aspect of the invention is the laminate formed according to the process above. As mentioned previously, a laminate with the desired properties (anti-fingerprint effect at optimal roughness) is hitherto unknown.

Further aspects of the invention provide a laminate based on a wood substrate with a gloss level of 0.5 to 5 at 60° and/or 1 to 15 at 85° and/or a surface roughness Rz of 0.1 μm up to 100 μm. Due to the shortcomings of previously known manufacturing methods, it has hitherto been impossible to form such laminates. However, they provide important features (anti-finger print) for kitchen- and wet-room environments and they can accommodate low-cost substrates. Preferably, substrates used are particleboards, MDF-, HDF- or OSB-boards, all of which may exhibit inhomogeneous density distributions.

### BRIEF DESCRIPTION OF THE DRAWINGS

In the following, a detailed description of exemplary embodiments is given by means of the accompanying figures, wherein:

FIG. 1 shows a vertical cross section of a carrier foil according to an embodiment of the invention.

FIG. 2 shows a vertical cross section of the coated carrier foil on a melamine resin film covering a substrate in a press. For clarity reasons, only an upper pressing plate is shown.

FIG. 3 shows a vertical cross section of a laminate produced with and according to an embodiment of the invention.

FIG. 4 depicts the process according to an embodiment of the invention in an exemplary fashion, wherein a transfer foil containing the carrier foil and the coating is introduced into a short cycle press already containing the resin-covered wood substrate, with the unloaded carrier foil and the laminate product leaving the press region.

FIG. 5 shows a wrinkled foil surface according to an embodiment of the present invention.

FIG. 6 shows a further wrinkled foil surface according to a further embodiment of the present invention.

### DETAILED DESCRIPTION OF THE PREFERRED EMBODIMENTS

Hereinafter, the present invention is described with reference to particular embodiments as illustrated in the attached figures. However, the present invention is not limited to the particular embodiments described in the following detailed description and represented in the figures, but rather the embodiments described simply exemplify the various aspects of the present invention, the scope of which is defined by the claims. Further modifications and variations of the present invention will become clear to those skilled in the art.

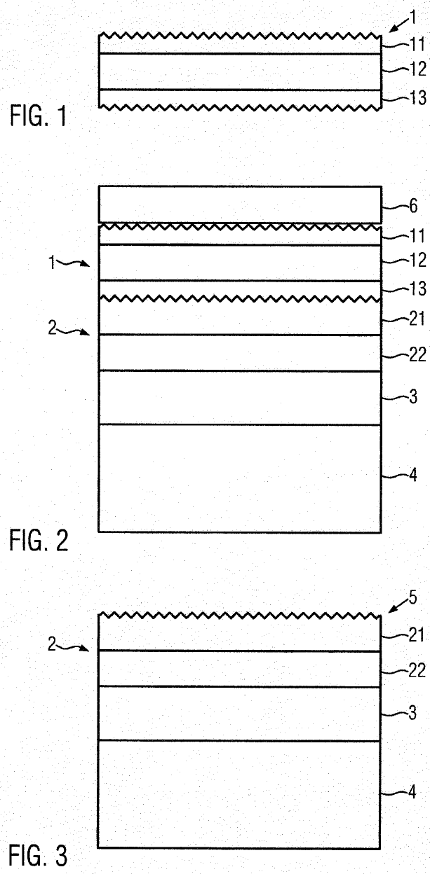

In FIG. 1, the carrier foil 1 is schematically shown with three sub-layers, namely an upper foil surface 11, a foil 12 and a lower foil surface 13. The sub-layers are shown and named with respect to their position when put on a substrate, i. e. the upper foil surface 11 faces the press 6, whereas the lower foil surface 13 faces the substrate 4 (which should not imply that there is no coating and/or melamine resin film between the lower foil surface 13 and the substrate 4). The foil 12 itself can comprise PET (polyethylene terephthalate) or any other suitable plastic material. It can further comprise any materials suitable for replacing plastic materials in high pressure/temperature applications.

The foil 12 can have a thickness of 30 μm to 500 μm, preferably 50 μm to 250 μm, more preferably 100 μm to 200 μm.

The lower and upper foil surfaces 11, 13 are microfolded surface structures with a roughness Rz of 0.1 μm up to 100 μm, preferably 1 μm up to 50 μm, more preferably 5 μm up to 15 μm according to ISO 4287. Preferentially their surface roughness RSm is 0.1-1000 μm, more preferably 0.5-500 μm, still more preferably 5-100 μm according to ISO 4287. The roughness Rz and RSm of the two surfaces can be the same but this is not necessary and the roughness of the two surfaces may be different.

The microfolded surface structure comprises varnish, e. g. irradiated acrylic varnish, with photoinitiators. A microfolded surface structure can then preferably be achieved by excimer treatment and final curing by UV or electron beam curing, for example by the method published in WO 2007/068 322 A1. Thereby 1 g/m² of varnish results in an average layer thickness of about 1 μm.

As an example, monochromatic irradiation of a wavelength of 172 nm at a power of 20 to 50 W/cm² for less than 10 seconds is applied to cure an upper layer of a mixture of the following (percentages in wt.-%): 20-90% of a radiation curable urethane acrylate, 10-50% radiation curable monomer like HDDA or TPGDA to control the viscosity, 0.1% to 3% of photoinitiator, 1-10% of matting agent. This upper layer comprises the wrinkled surface structure. Thereafter, the upper and/or lower foil surface 11, 13 is fully cured by larger wavelength UV light with higher penetration depth. Both foil surfaces can either comprise a different mixture within the above parameters or they can comprise substantially the same mixture.

The microfolding process preferably results in a wrinkled surface structure, wherein long channels are present. Theses long channels help to create pathways for air to escape.

The surface roughness RSm of the upper and lower foil surface 11, 13 is preferably 0.1-1000 μm, more preferably 0.5-500 μm, still more preferably 5-100 μm according to ISO 4287, but can otherwise be adjusted freely and independently to reach the desired reflectivity/anti finger print effect and to let air escape when pressure is applied, respectively.

The order in which upper and lower foil surfaces 11, 13 are created is irrelevant.

FIG. 2 shows the carrier foil 1 with a coating 2 on top of a melamine resin film 3 covered substrate 4 in a press 6. The carrier foil 1 with the coating 2 applied to it is also referred to as transfer foil 15 herein.

The coating 2 may comprise two distinct layers, wherein an upper coating layer 21 (the layer closer to the carrier foil) comprises not fully cured (i. e. at least some acrylic groups are still present, e. g. 10% or more) epoxy acrylates, polyester acrylates, or urethane acrylates, il e. varnish, or a mixture of the afore-mentioned varnishes in order to form a wear resistant outer layer for the final product. A lower coating layer 22 (the layer closer to the melamine resin film 3) may comprise a binder or primer such as acrylated melamine resin or other suitable adhesion promoters, such as Isocyanate. After both layers are deposited, both are fully cured. and the lower coating layer 22 serves as an adhesive layer that bonds with the melamine resin film 3.

The coating 2 is applied to the carrier foil and cured step-by-step by one of several established methods, such as a roller coater, slot dies or by curtain coating in order to provide the transfer foil 15.

Before entering the press 6, the wood substrate 4 is covered with a melamine resin film 3 (for example, melamine formaldehyde resin), which is preferably provided as a printed, decorative paper impregnated with melamine formaldehyde resin. Said melamine resin film is provided with a certain residual moisture (up to 10 wt.-%, preferably 4-6 wt.-%) and remaining latent reactivity, so that it bonds well to the coating 2 and the substrate 4 when heat and/or pressure is applied. The wood substrate 4 itself may preferably be provided as a particleboard, MDF- (medium density fiberboard), HDF- (high density fiberboard) or OSB-boards (oriented strand board).

FIG. 3 depicts a resulting laminate 5 structure with the coating 2 comprising an upper coating layer 21 and a lower coating layer 22 as described as well as a melamine resin film 3 between the coating and a wood substrate 4. The method of producing the laminate will be outlined in the following.

In order to produce a carrier foil 1, a foil 12 comprising PET or a plastic material with the properties described above is provided, a varnish is provided as a wet layer on one surface of the foil 12, and one of the upper and lower foil surfaces 11, 13 is formed by curing the varnish as described above, so that a microfolded wrinkled surface with a roughness Rz of 0.1 μm up to 100 μm, preferably 1 μm up to 50 μm, more preferably 5 μm up to 15 μm is achieved.

Thereafter the process is repeated for a second surface of the foil 12 in order to form the other of the upper and lower foil surfaces 11, 13 with a roughness Rz of 0.1 μm up to 100 μm, preferably 1 μm up to 50 μm, more preferably 5 μm up to 15 μm. As mentioned above, the upper and lower foil surfaces 11, 13 need not have the same roughness, which can be adjusted according to the desired effects.

As mentioned above, surface roughness RSm may preferably be between 0.1-1000 μm, more preferably 0.5-500 μm, still more preferably 5-100 μm according to ISO 4287.

With the carrier foil 1 as mentioned above, a transfer foil 15 containing the coating can be manufactured. The coating 2 can comprise an upper coating layer 21 on the lower foil surface 13 comprising acrylic or other varnish as described above and a lower coating layer 22 comprising acrylated melamine resin as described above thereon. As also described above, the upper coating layer 21 may not immediately be fully cured, while it may be fully cured, when the lower coating layer 22 is cured thereafter.

In order to then form the laminate 5, a carrier foil 1 or a transfer foil 15 as described above is used in a press to transfer a coating 2 to a wood substrate 4, wherein the coating 2 and the wood substrate 4 may have the composition or may comprise the features as described above with reference to FIG. 2.

When the carrier foil 1, the coating 2 (or the transfer foil 15 comprising both), the melamine resin film 3 and the substrate 4 are, in this order, present in the press 6, heat and/or pressure may be applied so that the melamine resin film may, for a short period of time, usually 30 seconds, flow, i. e. become at least partially fluid, also known as B-Stage behavior, and thus bond with the porous substrate 4 surface and the coating 2 or more specifically the lower coating layer 2 containing the acrylated melamine resin.

During this process, the residual moisture and water produced in a polycondensation reaction in the melamine resin film evaporates and the laminate becomes a rigid structure. The laminate may be produced with a counter-move layer, which is not depicted.

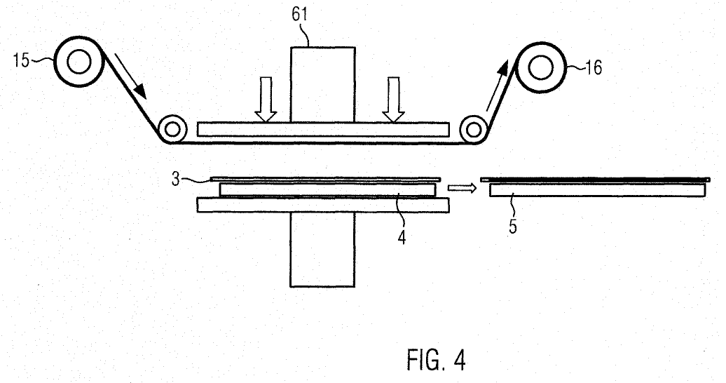

FIG. 4 shows the production process employing a short-cycle press 61 and transfer foil 15 scrolled off a roll and rolled back up unloaded 16 after one press cycle. The wood substrate 4 with the melamine resin film 3 on top is fed into the press before each cycle and leaves the press 6, 61 after pressure and/or heat is applied as the coated laminate 5 product. This technique thus allows the production of wood substrate 4 based laminates 5 with a wear-resistant coating comprising a gloss level of 0.5 to 5 at 60° and/or 1 to 15 at 85° and/or a surface roughness of 0.1 μm up to 100 μm. Therein, the wood substrate 4 may be provided as a particleboard, an MDF-, HDF- or OSB-board.

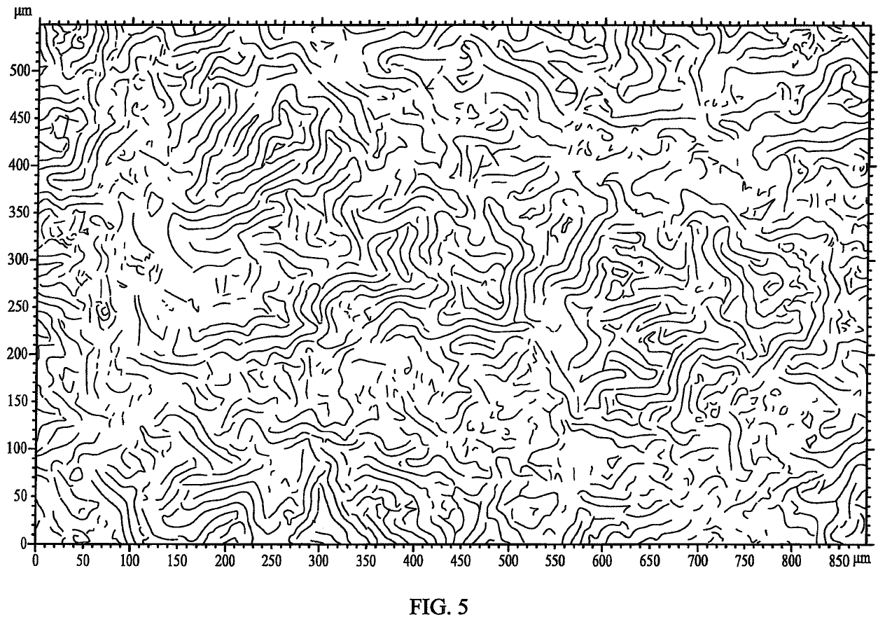

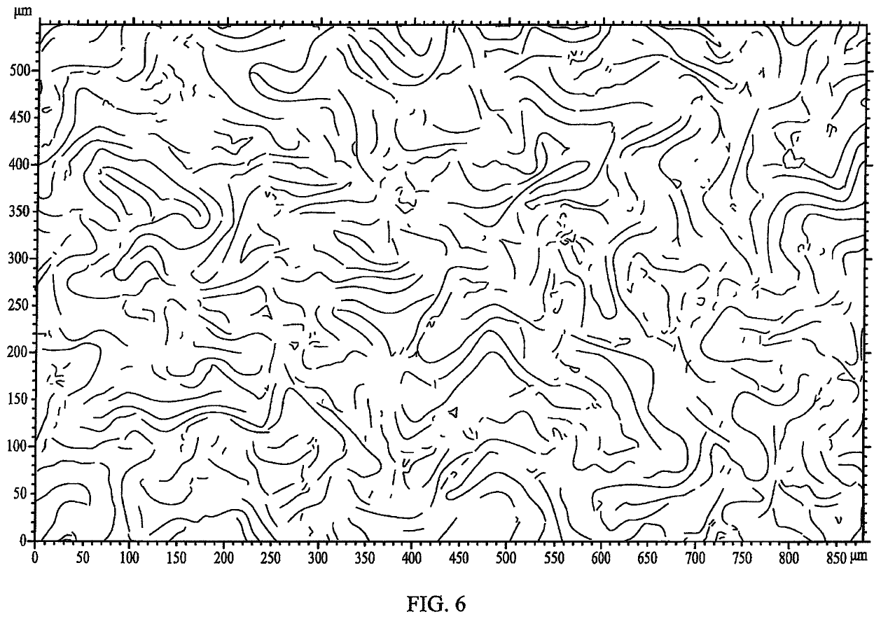

FIGS. 5 and 6 show interferometer profile measurements of the wrinkled surface as a black and white height profile of upper and/or lower foil surfaces 11, 13. Different structures with differently spaced channels are shown. However, the important structural features, such as long channels through which air can escape, are clearly visible. RSm is estimated between 10 μm for FIG. 5 and 25 μm for FIG. 6, however, these are merely exemplary views, which are in no way intended to limit the scope of the invention. The purpose of the channels is to enable the expulsion of air, which can still be achieved at much higher or even lower values for RSm, in the constraint mentioned above.

Even if the present invention has been described with reference to the embodiments described above, it is clear to those skilled in the art that it is possible to make different modifications, variations and improvements of the present invention in light of the teaching described above and in the attached claims without departing from the object and the scope of protection of the invention.

Finally, anything that is deemed known by those skilled in the art has not been described in order to avoid needlessly excessively obfuscating the described invention.

Consequently, the invention is not limited to the embodiments described above, but is only limited by the scope of protection of the attached claims.

What is claimed is:

1. A method for producing a multilayer laminate structure using a carrier foil in a press for transferring a coating onto a substrate covered with a melamine resin film, wherein said method comprises the following steps:
a) providing a carrier foil comprising a foil with an upper foil surface and a lower foil surface, wherein the lower foil surface facing toward the substrate has a roughness Rz of 0.1 μm up to 100 μm and the upper foil surface has a microfolded wrinkled surface with a roughness Rz of 0.1 μm up to 100 μm;
b) providing a coating on the lower foil surface of the carrier foil;
c) transferring the coating to the substrate covered by a melamine resin film by means of the carrier foil;
d) joining the coating with the substrate under pressure and/or heat with the press, wherein a profile of the lower foil surface is transferred to the coating, and
e) removing the carrier foil thereafter.

2. The method as recited in claim 1, wherein said step a) comprises the following sub-steps:
a1) providing the foil, the foil comprising PET;
a2) providing a varnish as a wet layer on the upper surface of the foil;
a3) forming the upper foil surface by curing the varnish in order to obtain a microfolded wrinkled surface with a roughness Rz of 0.1 μm up to 100 μm;
a4) providing a varnish as a wet layer on the lower surface of the foil; and
a5) forming the lower foil surface by curing the varnish in order to obtain a microfolded wrinkled surface with a roughness Rz of 0.1 μm up to 100 μm.

3. The method as recited in claim 1, wherein the upper foil surface has a roughness Rz of 1 μm up to 50 μm.

4. The method as recited in claim 1, wherein the microfolded wrinkled structure comprises channels extending to an edge of the foil and configured to create pathways for air to escape to the edge of the foil.

5. The method as recited in claim 1, wherein the roughness RSm of the upper foil surface is 0.1 μm up to 1000 μm.

6. The method as recited in claim 1, wherein the roughness Rz and/or RSm of the upper foil surface is the same as the roughness Rz and/or RSm, respectively, of the lower foil surface.

7. The method as recited in claim 1, wherein the foil comprises PET.

8. The method as recited in claim 1, wherein the upper and/or the lower foil surface comprises radiation-cured acrylic varnish.

9. The method as recited in claim 1, wherein the coating comprises acrylic varnish comprising a radiation-curable acrylate, and said step b) further comprises
b1) curing the acrylic varnish.

10. The method as recited in claim 9, wherein said coating comprises an upper coating layer and a lower coating layer and said step b) comprises the following sub-steps:
depositing the upper coating layer comprising acrylic varnish on the lower foil surface of the foil, wherein the acrylic varnish is not fully cured;
providing the lower coating layer comprising acrylated melamine resin or other suitable adhesion promoters on the upper coating layer; and
fully curing both the upper coating layer and lower coating layer.

11. The method as recited in claim 1, wherein the substrate is a wood substrate.

12. The method as recited in claim 1, wherein the press is a short-cycle press.

13. The method as recited in claim 1, wherein the coating comprises an upper coating layer comprising acrylic varnish and a lower coating layer comprising acrylated melamine resin or other suitable adhesion promoters.

14. A laminate obtained by the method as recited in claim 1.

15. The laminate as recited in claim 14 based on a wood substrate comprising a gloss level of 0.5 to 5 at 60° and/or 1 to 15 at 85°.

16. The laminate as recited in claim 14 based on a wood substrate comprising a surface roughness of 0.1 μm up to 100 μm.

17. The laminate as recited in claim 15 based on a wood substrate comprising a surface roughness of 0.1 μm up to 100 μm.

18. The method as recited in claim 9, wherein the radiation-curable acrylate is selected from the group consisting of epoxy acrylates, polyester acrylates, and urethane acrylates.

19. The method as recited in claim 11, wherein the wood substrate is selected from the group consisting of particleboard, MDF-, HDF- and OSB-board.
